(19) United States
(12) Patent Application Publication
(10) Pub. No.: US 2024/0376747 A1
(43) Pub. Date: Nov. 14, 2024

(54) SWING DOOR HANDLE AND ESCUTCHEON

(71) Applicant: ASSA ABLOY Fenestration, LLC, Rochester, NY (US)

(72) Inventors: Peter J. Minter, Reno, NV (US); Marc Wesley Fullenwider, Reno, NV (US); Jacob Baitx, Reno, NV (US); Alexander Parsley, Reno, NV (US); Rick Beemsterboer, Reno, NV (US)

(21) Appl. No.: 18/657,194

(22) Filed: May 7, 2024

Related U.S. Application Data
(60) Provisional application No. 63/464,796, filed on May 8, 2023.

(51) Int. Cl. E05B 9/00; E05B 15/02

(52) U.S. Cl. CPC E05B 9/002; E05B 15/02

(57) ABSTRACT

A handle and escutcheon set for a swing door includes an interior handle set and an exterior handle and spindle pre-installed on an escutcheon. The interior handle set comprises an interior escutcheon assembly and a base plate assembly including a base plate, an upper shuttle, a lower shuttle, and a lock gasket. The base plate is first fastened to the door and the exterior handle set and then the interior escutcheon is snapped onto the base plate, thereby securing it in place via resiliently-biased upper and lower shuttles.

### BACKGROUND OF THE INVENTION

### 1. Field of the Invention

The present invention relates generally to handle sets for swing doors, and more specifically, to an improved handle and escutcheon set which allows for simpler and faster installation on the interior and exterior faces of a swing door.

### 2. Description of Related Art

American Architectural Manufacturer's Association (AAMA) 903 establishes voluntary test procedures and performance criteria for evaluating lever handle sets designed for use with multipoint hardware on side-hinged doors. This standard gives industry professions a tool for evaluating door handle sets as standalone hardware. AAMA 903-909 requires that each handle comes pre-attached to the escutcheon and further that the attachment fasteners must be hidden upon installation on a door.

Therefore, a need exists for a handle and escutcheon set which allows for simple installation while meeting the AAMA 903-909 standard.

### SUMMARY OF THE INVENTION

Bearing in mind the problems and deficiencies of the prior art, it is therefore an object of the present invention to provide an improved handle set for a swing door which simplifies installation and provides an aesthetic appearance.

It is another object of the present invention to provide an improved handle set for a swing door which provides a simplified means to remove the installed handle set while concealing the attachment fasteners.

A further object of the invention is to provide an improved handle set for a swing door which provides a snap-in method of assembly.

Still other objects and advantages of the invention will in part be obvious and will in part be apparent from the specification.

The above and other objects, which will be apparent to those skilled in the art, are achieved in the present invention which is directed in one aspect to an escutcheon assembly comprising a base plate assembly including an elongated base plate having lateral sides and longitudinal sides, and upper and lower shuttles proximate opposing lateral sides of the base plate, each of the upper and lower shuttles normally biased in opposing directions by at least one resilient biasing mechanism and translatable axially within an interior of the base plate. Each of the upper and lower shuttles further includes a projection which extends axially beyond the lateral sides of the base plate when in a biased position. The escutcheon assembly further comprises an escutcheon plate including ramped surfaces on opposing lateral ends thereof, one of the lateral ends further including a recessed portion adjacent and anterior to one of the ramped surfaces and the other of the lateral ends including a slotted portion adjacent and anterior to the other ramped surface. When installed on a door surface, the escutcheon is mechanically coupled to the base plate such that one of the upper or lower shuttle projections is received within the recessed portion of the escutcheon and the other of the upper or lower shuttle projections is received within the slotted portion of the escutcheon. The slotted portion of the escutcheon provides access to the upper or lower shuttle engaged therewith, thereby permitting force to be applied to the projection to force the upper or lower shuttle into the interior of the base plate assembly and facilitating disengagement of the upper or lower shuttle projection from the second escutcheon recessed portion to permit removal of the escutcheon.

In an embodiment, mechanically coupling the escutcheon to the base plate causes each of the upper and lower shuttles to first translate in an opposite direction as a result of the upper and lower shuttle projections contacting the ramped surfaces of the escutcheon to compress the resilient biasing mechanisms which normally bias the upper and lower shuttles toward the lateral sides of the base plate. In at least one embodiment, the upper and lower shuttles are translatable within upper and lower recesses of the base plate, wherein laterally-extending ledges integral with or connected to an interior surface of the base plate define a proximal end of each of the upper and lower recesses, and wherein each of the at least one resilient biasing mechanisms abuts the laterally-extending ledges. In one or more embodiments, the at least one resilient biasing mechanism is a pair of springs.

In another aspect, the present invention is directed to a method of installing a handle set and escutcheon assembly on a swing door. The method may comprise aligning a base plate assembly with a portion of a first surface of the swing door, the base plate assembly including an elongated base plate having lateral sides and longitudinal sides, and upper and lower shuttles proximate opposing lateral sides of the base plate, each of the upper and lower shuttles normally biased in opposing directions by at least one resilient biasing mechanism and translatable axially within an interior of the base plate, each of the upper and lower shuttles further including a projection which extends axially beyond the lateral sides of the base plate when in a biased position; aligning a first escutcheon assembly with the base plate assembly on an opposing surface of the swing door, the first escutcheon assembly including a first escutcheon and a handle mechanically coupled thereto via a spindle hub, the first escutcheon assembly further including a spindle extending from the handle in a direction normal to a longitudinal axis of the first escutcheon; and attaching the base plate assembly to the first escutcheon assembly via attachment fasteners extending through the swing door. The method further comprises mechanically coupling a second escutcheon to the base plate by compressing at least one of the at least one biasing mechanisms to retract at least one of the upper or lower shuttle projections into the interior of the base plate, such that the attachment fasteners are concealed and inaccessible when the second escutcheon is mechanically coupled to the base plate.

In at least one embodiment, the second escutcheon may include ramped surfaces on opposing lateral ends thereof, one of the lateral ends further including a recessed portion adjacent and anterior to one of the ramped surfaces and the other of the lateral ends including a slotted portion adjacent and anterior to the other ramped surface, and the step of mechanically coupling the second escutcheon to the base plate may further comprise engaging the upper and lower shuttle projections with the second escutcheon ramped surfaces to bias the upper and lower shuttles toward the interior of the base plate; and receiving one of the upper or lower shuttle projections within the second escutcheon recessed portion and receiving the other of the upper or lower shuttle projections within the second escutcheon slotted portion.

To remove the second escutcheon, the method may further comprise the steps of engaging the upper or lower shuttle projection through the second escutcheon slotted portion to force the upper or lower shuttle into the interior of the base plate assembly; and applying a force away from the base plate assembly to disengage the upper or lower shuttle projection from the second escutcheon recessed portion to permit removal of the second escutcheon.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a perspective view of an embodiment of the swing door handle and escutcheon set of the present invention.

FIG. 2 is a perspective view of the exterior-side handle and escutcheon of the embodiment of FIG. 1.

FIG. 3 is a perspective view of the interior-side handle set assembly of the embodiment of FIG. 1.

FIG. 4 is an exploded perspective view of an interior-side base plate and escutcheon assembly according to an embodiment of the present invention.

FIG. 5 is a perspective view of the interior escutcheon of FIG. 4.

FIG. 6 is a perspective view of the interior base plate of FIG. 4.

FIG. 7 is a perspective view of the interior base plate assembly of FIG. 4.

FIG. 8 is an exploded perspective view of the interior base plate assembly of FIG. 7.

FIG. 9 is a perspective view of an upper portion of the interior base plate assembly of FIG. 7.

FIG. 10 is a perspective view of a lower portion of the interior base plate assembly of FIG. 7.

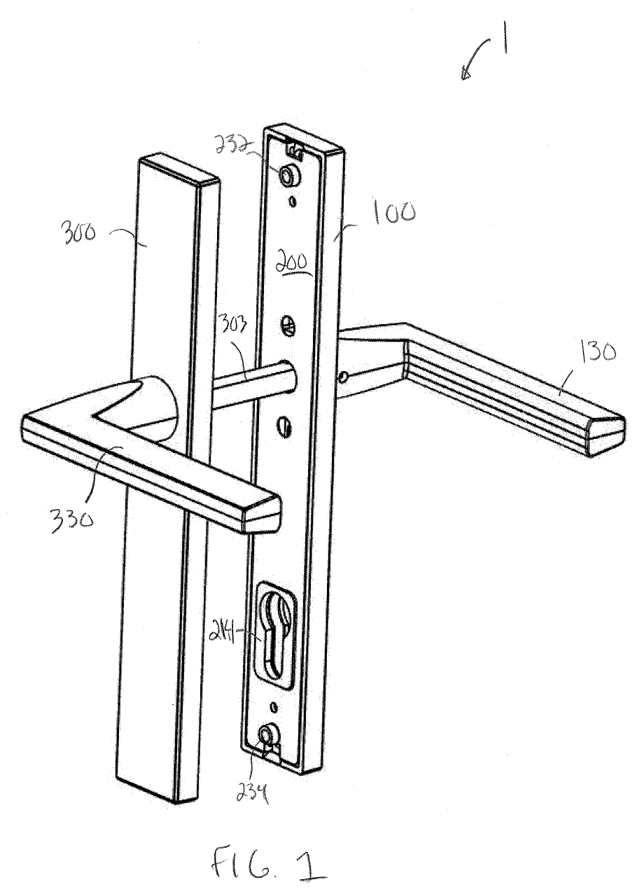

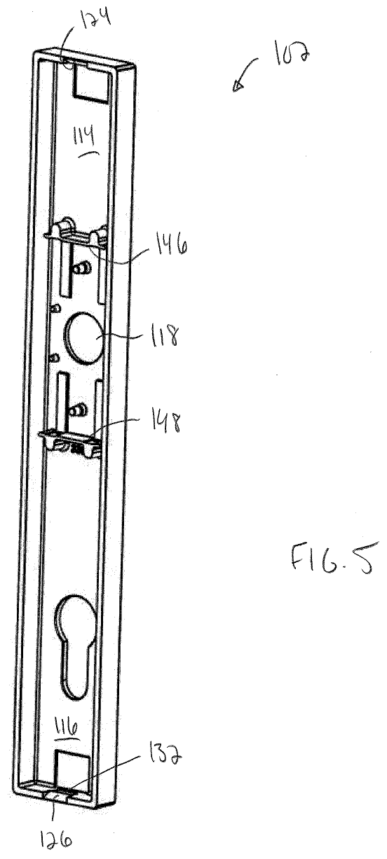

FIG. 1I is a perspective view of a lower portion of the interior escutcheon of FIG. 5.

FIG. 12 is a perspective view of an upper portion of the interior escutcheon of FIG. 5.

### DESCRIPTION OF THE EMBODIMENT(S)

In describing the embodiments of the present invention, reference will be made herein to FIGS. 1-12 of the drawings in which like numerals refer to like features of the invention.

Certain terminology is used herein for convenience only and is not to be taken as a limitation of the invention. For example, words such as “upper,” “lower,” “left,” “right,” “horizontal,” “vertical,” “upward,” “downward,” “clockwise,” “counterclockwise,” “longitudinal,” “lateral,” or “radial” merely describe the configuration shown in the drawings. Indeed, the referenced components may be oriented in any direction and the terminology, therefore, should be understood as encompassing such variations unless specified otherwise. For purposes of clarity, the same reference numbers may be used in the drawings to identify similar elements.

Additionally, in the subject description, the words “exemplary,” “illustrative,” or the like are used to mean serving as an example, instance, or illustration. Any aspect or design described herein as “exemplary” or “illustrative” is not intended to be construed as preferred or advantageous over other aspects or design. Rather, the use of the words “exemplary” or “illustrative” is merely intended to present concepts in a concrete fashion.

Referring now to FIGS. 1-12, inclusive, an exemplary embodiment of a swing door handle and escutcheon assembly according to the present invention is shown. As described and shown herein, the handle set 1 of the present invention may be used on a standard 92 mm lock with an attachment hole pattern set 215.9 mm apart; however, it should be understood by those skilled in the art that the handle set of the present invention is not limited to standard spacing and may be adapted to fit any other lock spacing. A perspective view of the complete handle set is shown in FIG. 1, and the set includes a two-part interior handle assembly 100 comprising an escutcheon and base plate assembly, and an exterior handle and spindle assembly 300 pre-installed onto the exterior escutcheon, as will be described in more detail herein.

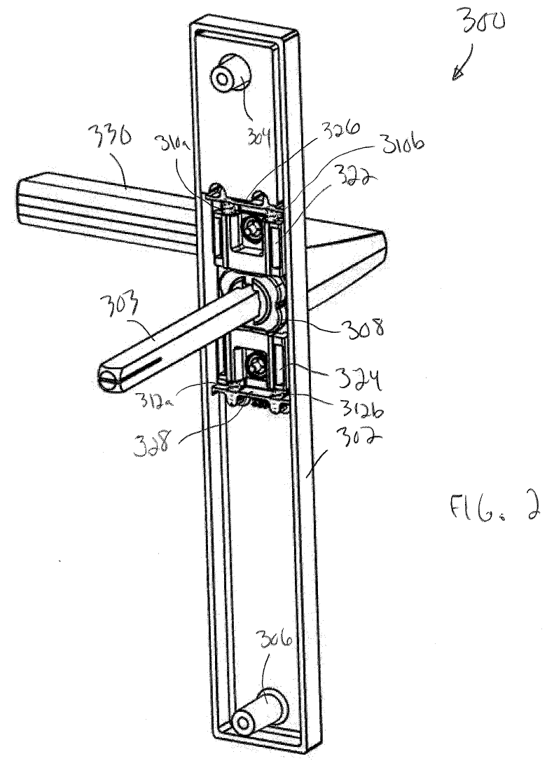

Referring now to FIG. 2, the exterior escutcheon assembly 300 includes an elongated escutcheon plate 302 having a pair of internally threaded posts 304, 306 proximate opposing lateral ends thereof for receiving a fastener to secure the escutcheon 302 to the surface of the door, and an exterior handle 330 pre-installed thereon. Extending from handle 330 through aperture 318 (not shown) in escutcheon 302 is spindle 303 which extends normal to a longitudinal axis of the escutcheon. Handle 330 is mechanically coupled to spindle 303 via spindle hub 308 which rotates spindle 303 about a longitudinal axis when either the exterior handle 330 or interior handle 130 is rotated between locked and unlocked positions. Shuttles 322, 324 on opposing sides of hub 308 are positioned to bias hub 308 and spindle 303 to a neutral position when both handles are released. Shuttles 322, 324 are biased in opposing directions by a one or more resilient members, shown in FIG. 2 as pairs of springs 310a, 310b and 312a, 312b, respectively, which abut laterally-extending ledges 326, 328 integral with or connected to an interior surface of escutcheon 302. As handle 330 or 130 is rotated, springs 310a, 310b and 312a, 312b compress against ledges 326 and 328, respectively, such that when both handles are released, the expansion of the springs causes the spindle 303 to return to the neutral position.

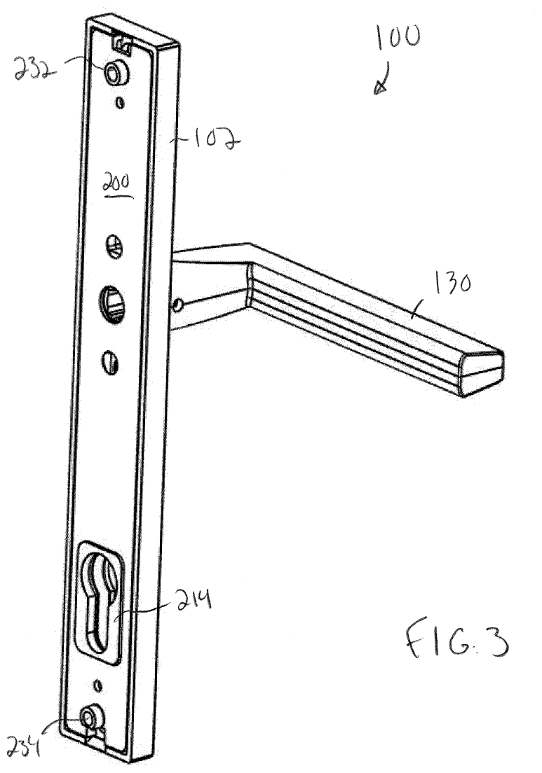

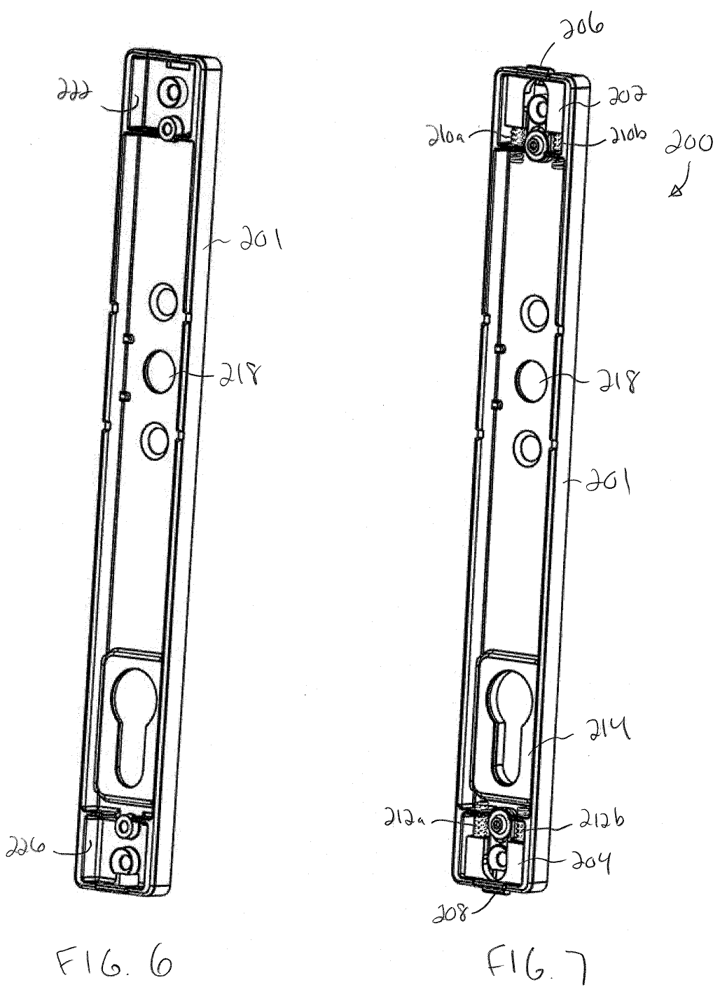

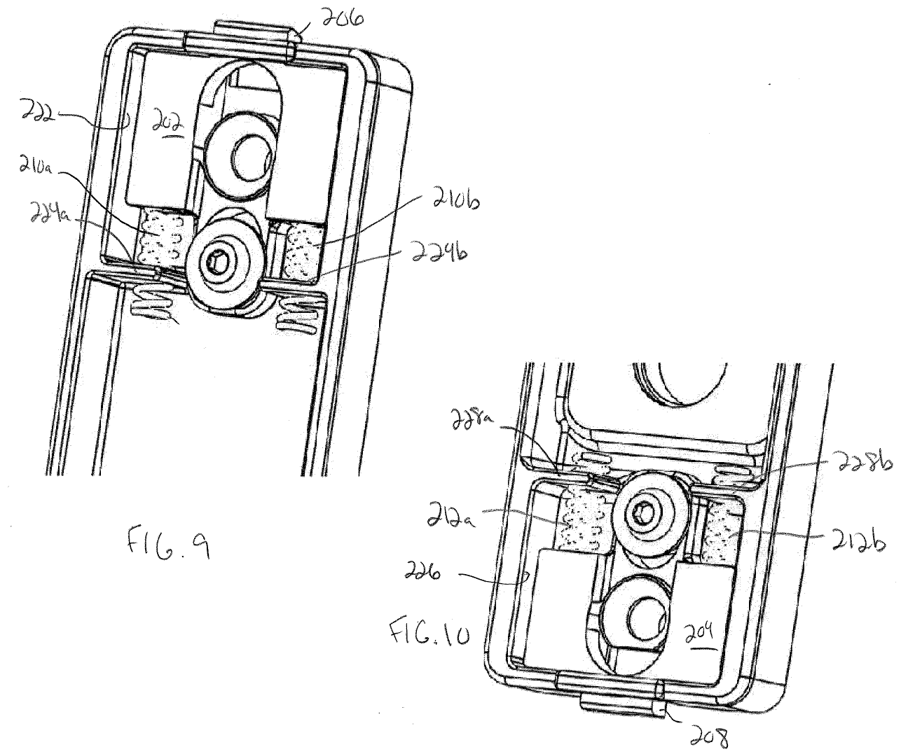

The interior handle set comprises an interior escutcheon plate 102 and a base plate assembly 200 (FIG. 3). During assembly, the base plate assembly 200 is first fastened to the door surface on the room interior-facing surface of the door and the exterior handle set 300 and then the interior escutcheon 102 and handle 130 is snapped onto the base plate assembly 200, thereby securing it in place via two spring detent features, as will be described in further detail below. As best seen in FIG. 8, the base plate assembly 200 comprises at least the following primary components: a base plate 201, an upper shuttle 202, a lower shuttle 204, and a lock gasket 214. The upper and lower shuttles 202, 204 are movably affixed within upper and lower interior recesses 222, 226 of base plate 201 such that they can traverse vertically. Base plate 201 serves as the attachment point for the interior escutcheon 102, as well as the mounting point for the exterior handle set 300. As shown in FIGS. 1 to 4, the exterior handle set 200 is attachable to the door via two M4 screws (not shown) driven through internally threaded posts 232, 234 of base plate 201 of the interior handle assembly 100, through the door (not shown), and received within blind or hidden internally threaded posts 304, 306 of exterior escutcheon assembly 330. In this manner, the attachment fasteners are hidden by the exterior escutcheon 302 when viewed from the exterior-facing surface of the door and hidden by the interior escutcheon 102 when viewed from the interior-facing surface of the door. Spindle 303 extends through aperture 318 in escutcheon 302, through a bored hole in the swing door, and through aperture 218 in base plate 201 (FIGS. 6-8).

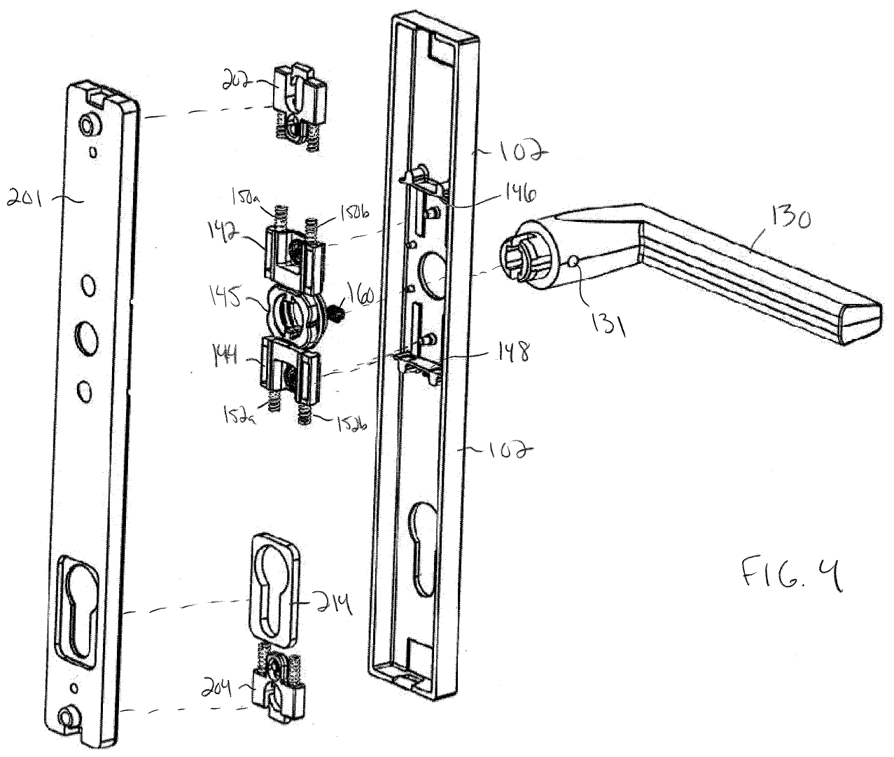

As further shown in FIG. 4, interior escutcheon plate 102 includes a spindle hub 145 secured therein and surrounding spindle aperture 118 for receiving spindle 303 and rotating spindle 303 about its longitudinal axis when handles 130, 330 are rotated between locked and unlocked positions. Shuttles 142, 144 on opposing sides of hub 145 are positioned to bias hub 145 and spindle 303 to a neutral position when both handles are released. Shuttles 142, 144 are biased in opposing directions by one or more resilient members, shown in FIG. 4 as pairs of springs 150a, 150b and 152a, 152b, respectively, which abut laterally-extending ledges 146, 148 integral with or connected to an interior surface of escutcheon 102. As either handle 130 or 330 is rotated, springs 150a, 150b and 152a, 152b compress against ledges 146 and 148, respectively, such that when the handles are released, the expansion of the springs causes the spindle to return to the neutral position.

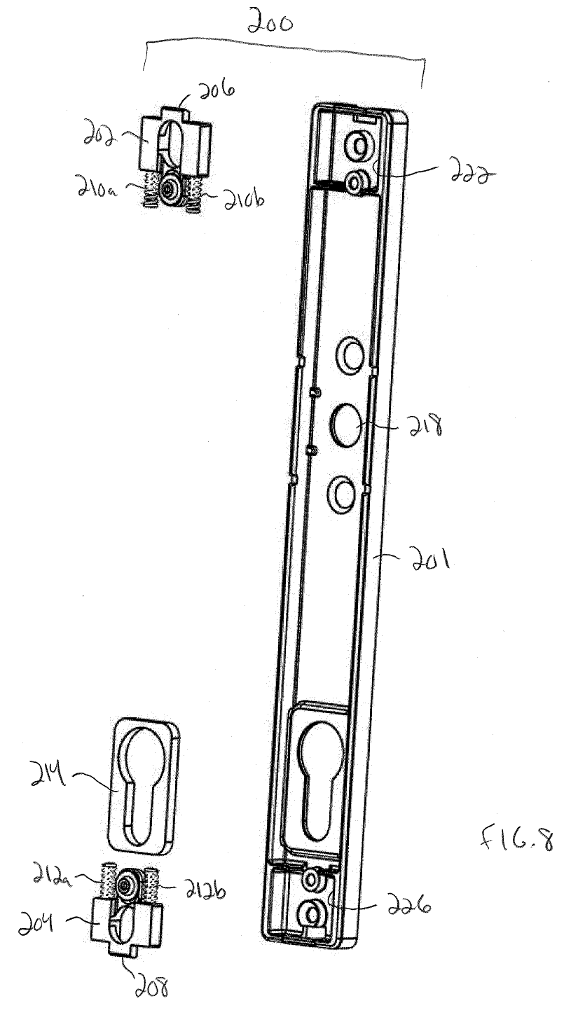

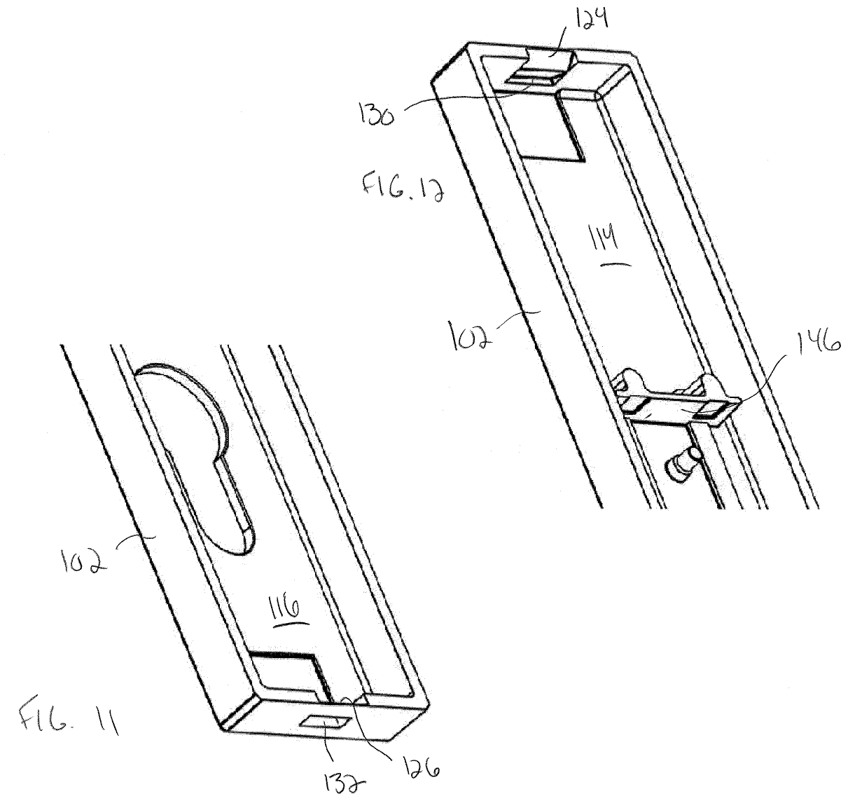

Referring now to FIGS. 6-12, during installation the upper and lower portions 114, 116 of the interior escutcheon 102 interact with the upper and lower shuttles 202, 204 of the base plate assembly 200 to secure the escutcheon 102 to the base plate 201. As best seen in FIGS. 7-10, the shuttles 202, 204 are biased in opposing directions by one or more resilient members, shown in the Figures as pairs of springs 210a, 210b and 212a, 212b, respectively, which abut laterally-extending ledges 224a, 224b of upper recess 222 of base plate 201, and ledges 228a, 228b of lower recess 226, respectively, of base plate 201. As shown in FIGS. 9-10, ledges 224a, 224b and 228a, 228b define the proximal ends of recesses 222 and 226, respectively, or the ends nearest the center or midpoint of base plate 201 along its longitudinal axis, and are integral with or connected to an interior surface of base plate 201. It should be understood by those skilled in the art that resilient members other than springs are not precluded, nor are a pair of resilient members required to bias each shuttle, as the present invention may operate as intended with less than or greater than two resilient members for each shuttle. Each shuttle 202, 204 includes a projection 206, 208 which extends axially beyond the lateral sides of the base plate 201 (FIGS. 9 and 10) for interaction with portions of the interior escutcheon 102. As best seen in FIG. 11, interior escutcheon lower end 116 includes a slotted portion 132 adjacent and anterior to ramped surface 126, wherein slotted portion 132 receives projection 208 of shuttle 204 therein when escutcheon 102 is attached to the base plate assembly 200. Advantageously, slotted portion 132 is accessible from the exterior of the assembly. Similarly, as shown in FIG. 12, upper portion 114 of interior escutcheon 102 includes a recessed portion 130 anterior to ramped surface 124 for receiving projection 206 of shuttle 202. In at least one embodiment, in contrast to slotted portion 132, recess 130 is closed and is not accessible from the exterior of the assembly.

During installation of the handle and escutcheon set of the present invention on a swing door, as the interior escutcheon 102 is pushed onto the base plate assembly 200, each of the shuttles 202, 204 hits ramped surfaces 124, 126 of the interior escutcheon, thereby compressing springs 210a, 210b, 212a, 212b against base plate ledges 224a, 224b and 228a, 228b, respectively, and forcing the shuttles in the direction of the interior of an enclosure formed by the escutcheon 102 and base plate 201. As the interior escutcheon 102 is pressed fully onto the base plate assembly 200, projections 206, 208 clear the ramped surfaces 124, 126 thereby allowing the springs to expand. As such, each of the shuttles 202, 204 is biased axially by the springs, away from the center of the enclosure, such that upper shuttle projection 206 is received in escutcheon recess 130 and lower shuttle projection 208 is received within slotted portion 132, thereby locking the interior escutcheon 102 onto the base plate assembly 200.

In at least one embodiment, as shown herein, the configuration of the handle and escutcheon set of the present invention has a hidden top shuttle 202 and an accessible lower shuttle 204 when looking at the fully installed handle set 1 on the door (FIGS. 11-12). In contrast to handle sets of the prior art, adding visibility and accessibility for the lower shuttle 204 allows the user to insert a device, such as a flat head screwdriver, through slotted portion 132 at the lower end 116 of the interior escutcheon to force the lower shuttle 204 up into the interior of the base plate, overcoming the biasing force of springs 212a, 212b and thereby allowing the interior escutcheon assembly to be easily removed from the base plate assembly 200 to access the previously concealed attachment fasteners. It should be understood by those skilled in the art that, functionally, the lock features would function in any combination of hidden and concealed attachment points.

Advantageously, the functionality of the present design allows the interior handle 130 to be pushed straight on to the door spindle 303 that is already installed and limits the direction the interior handle can be assembled in.

As shown, spindle 303 is otherwise conventional, and handle 130 may be tightened against the exterior of spindle 303 via set screw 160 inserted through an opening 131 in the side surface of handle 130, as shown in FIG. 4. However, in another embodiment, the exterior escutcheon assembly may include a split or forked spindle 303′ extending through exterior escutcheon 302 from the exterior handle 330, wherein the forked spindle is designed to meet the proposed load requirements that are currently in development with AAMA. The forked spindle design relies on the interaction between a pair of prongs of the spindle 303′ and a custom conical set screw. The set screw may be threaded with a left-handed thread so that when the user tightens the screw they are pulling the screw out of the interior handle 130. As the user unscrews the set screw, the conical section of the set screw hits a chamfered section of the spindle 303′, thereby causing the spindle to expand within the handle 130 and secure firmly therein. In at least one embodiment, the conical set screw is in tension, which will prevent the screw from backing out due to the vibrations generated when opening and closing a door. This will require less maintenance from the end user as they will not need to tighten the set screw nearly as often as other set screws.

It should be understood by those skilled in the art that in other embodiments the way the split or forked spindle is expanded can vary and does not need to be a set screw. The intended clamping may instead be generated by wedging or pressing the spindle against the inside of the handle it is attaching to.

Thus, the present invention provides one or more of the following advantages. The present invention provides an improved swing door handle set which allows for simple installation while meeting the AAMA 903-909 standard, while also allowing for easy removal despite concealing the attachment fasteners. To install the handle set, the base plate is first fastened to the door and the exterior handle set and then the interior escutcheon is snapped onto the base plate, thereby securing it in place via two spring detent features at the top and bottom of the interior escutcheon. A slotted portion at the lower end of the interior escutcheon allows the user to insert a device such as a flat head screwdriver through the slot to push a spring-biased lower shuttle up into the recess formed by the escutcheon and base plate to allow the interior escutcheon assembly to be easily removed from the base plate assembly and providing access to the attachment screws.

While the present invention has been particularly described, in conjunction with one or more specific embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. An escutcheon assembly, comprising:
a base plate assembly including an elongated base plate having lateral sides and longitudinal sides, and an upper shuttle and a lower shuttle proximate opposing lateral sides of the base plate, each of the upper and lower shuttles normally biased in opposing directions by at least one resilient biasing mechanism and translatable axially within an interior of the base plate, each of the upper and lower shuttles further including a projection which extends axially beyond the lateral sides of the base plate when in a biased position; and
an escutcheon including ramped surfaces on opposing lateral ends thereof, one of the lateral ends further including a recessed portion adjacent and anterior to one of the ramped surfaces and the other of the lateral ends including a slotted portion adjacent and anterior to the other ramped surface,
wherein when installed on a door surface, the escutcheon is mechanically coupled to the base plate such that one of the upper or lower shuttle projections is received within the escutcheon recessed portion and the other of the upper or lower shuttle projections is received within the escutcheon slotted portion.

2. The escutcheon assembly of claim 1 wherein mechanically coupling the escutcheon to the base plate causes each of the upper and lower shuttles to first translate in an opposite direction as a result of the upper and lower shuttle projections contacting the escutcheon ramped surfaces.

3. The escutcheon assembly of claim 2 wherein translation of the upper and lower shuttles in the opposite direction is caused by compression of the at least one resilient biasing mechanism as a result of the contact with the escutcheon ramped surfaces.

4. The escutcheon assembly of claim 1 wherein the upper and lower shuttles are translatable within upper and lower recesses of the base plate.

5. The escutcheon assembly of claim 4 further including laterally-extending ledges integral with or connected to an interior surface of the base plate, the laterally-extending ledges defining a proximal end of each of the upper and lower recesses.

6. The escutcheon assembly of claim 5 wherein each of the at least one resilient biasing mechanisms abuts the laterally-extending edges.

7. The escutcheon assembly of claim 1 wherein the at least one resilient biasing mechanism is a pair of springs.

8. The escutcheon assembly of claim 1 further including at least one internally-threaded post proximate each of the base plate lateral sides, the internally-threaded posts for receiving an attachment fastener to secure the base plate assembly to a door surface.

9. The escutcheon assembly of claim 8 wherein the attachment fasteners are concealed and inaccessible when the escutcheon is mechanically coupled to the base plate.

10. The escutcheon assembly of claim 1 wherein the escutcheon slotted portion provides access to the upper or lower shuttle engaged therewith when the escutcheon is mechanically coupled to the base plate.

11. A method of installing a handle set and escutcheon assembly on a swing door, comprising:
aligning a base plate assembly with a portion of a first surface of the swing door, the base plate assembly including an elongated base plate having lateral sides and longitudinal sides, and upper and lower shuttles proximate opposing lateral sides of the base plate, each of the upper and lower shuttles normally biased in opposing directions by at least one resilient biasing mechanism and translatable axially within an interior of the base plate, each of the upper and lower shuttles further including a projection which extends axially beyond the lateral sides of the base plate when in a biased position;
aligning a first escutcheon assembly with the base plate assembly on an opposing surface of the swing door, the first escutcheon assembly including a first escutcheon and a handle mechanically coupled thereto via a spindle hub, the first escutcheon assembly further including a spindle extending from the handle in a direction normal to a longitudinal axis of the first escutcheon;
attaching the base plate assembly to the first escutcheon assembly via attachment fasteners extending through the swing door; and
mechanically coupling a second escutcheon to the base plate by compressing at least one of the at least one biasing mechanisms to retract at least one of the upper or lower shuttle projections into the interior of the base plate,
wherein the attachment fasteners are concealed and inaccessible when the second escutcheon is mechanically coupled to the base plate.

12. The method of claim 11 wherein the second escutcheon includes ramped surfaces on opposing lateral ends thereof, one of the lateral ends further including a recessed portion adjacent and anterior to one of the ramped surfaces and the other of the lateral ends including a slotted portion adjacent and anterior to the other ramped surface, and wherein the step of mechanically coupling the second escutcheon to the base plate further comprises:
engaging the upper and lower shuttle projections with the second escutcheon ramped surfaces to bias the upper and lower shuttles toward the interior of the base plate; and
receiving one of the upper or lower shuttle projections within the second escutcheon recessed portion and receiving the other of the upper or lower shuttle projections within the second escutcheon slotted portion.

13. The method of claim 12 further comprising the steps of:
engaging the upper or lower shuttle projection through the second escutcheon slotted portion to force the upper or lower shuttle into the interior of the base plate assembly; and
applying a force away from the base plate assembly to disengage the upper or lower shuttle projection from the second escutcheon recessed portion to permit removal of the second escutcheon.
